(19) United States
(12) Patent Application Publication
(10) Pub. No.: US 2006/0129662 A1
(43) Pub. Date: Jun. 15, 2006

(54) Method and apparatus for a service integration system

(76) Inventors: Alon Lelcuk, Ramot Me'ir (IL); Michael Meller, Petach Tikva (IL); Abraham Rosenbach, Raanana (IL)

Correspondence Address: BROWDY AND NEIMARK, P.L.L.C.;624 NINTH STREET, NW, SUITE 300, WASHINGTON, DC, 20001-5303, US

(21) Appl. No.: 10/530,864

(22) PCT Filed: Sep. 25, 2003
(86) PCT No.: PCT/IL03/00767

§ 371 Date: Nov. 15, 2005

Related U.S. Application Data
(60) Provisional application No. 60/416,914, filed on Oct. 9, 2002.

(51) Int. Cl. G06F 15/173

(52) U.S. Cl. 709/223

(57) ABSTRACT

A software-implemented, distributed service integration system which provides an open environment for the development of new services, and their integration with the existing network, with the integration being performed by the service integration system administrator, which is also responsible for the service development. Thus, the procedure of developing and integrating of new services is shorter and cheaper than is common in telephony service integration systems. An example of a new service which is integrated with the existing network infrastructure includes the development by the service developer of a sophisticated billing service that uses a carrier's billing infrastructure. The inventive system also provides, through a modifiable policy defined by the system administrator, service-level control of the packet flow both within the service integration system and between the service integration system and the communications network. The inventive system also provides visibility into the signaling process to services deployed on it, offering direct communication with different protocols such as IP, SS7 etc., by means of network adaptation components.

### FIELD OF THE INVENTION

The present invention relates generally to communications network services. More specifically, the present invention relates to a distributed service integration system for communication networks, implemented as an application server, that enables the deployment, execution and management of network services.

### BACKGROUND OF THE INVENTION

Modern service integration and execution systems have the capability of providing users with advanced network services, services which give some sort of special functionality to a user during a network session. A network session is a single sequence of events that begins upon an initiating event and ends with a terminating event, for instance, a telephone call, access to a Web location, etc.

When a session that involves the execution of a service is initiated, there are up to three possible basic types of data that are channeled, namely the session handling data, the actual media transferred (e.g., voice, video streams etc.), and the service related data.

The service related data comprises triggers or requests that call for the activation of a service. In any network that supports the use of services there is a component in charge of recognizing these triggers and requests. Once these components recognize the need for the execution of a service, a service integration system is contacted with the required information for the execution and provisioning of the required service.

These service integration systems can be described in general as having two main functionalities: (a) the application functionality, in which the service logic of the various services is installed; (b) a set of generic platform functionalities that are developed by various vendors which are usually the major equipment vendors such as Alcatel, Nortel, Ericsson and others, that are used by the various services.

The service integration system, which is responsible for the execution and the managing of the services supported by a communication network, defines what services will be provided by a certain network. These components are currently provided by certain providers, which, as abovementioned, are usually the major communications equipment vendors.

There are several practical hardships with the current service integration technology. Firstly, the current technology usually provides closed, proprietary systems (i.e. addition and deployment of new services can only be made by the providers of these proprietary systems). As a result, addition of new services as well as their deployment is a very lengthy and costly task. For instance, if a user is interested in adding a new service to his network, according to the prior art, he would have to address the provider of the system integration system, and request for the development and deployment of the new service. This is true with respect to any requested service but for the most basic services. For instance, as far as telephony networks are concerned, from the time a certain service is requested until it becomes operational, as many as two years or more may go by, and as a result of the lengthy duration, and the complicated procedure, it will also result in being very expensive. Two other implications originating from the fact that service integration systems in accordance with the prior art are closed, proprietary systems, are: (i) the standard software based development tools cannot be used; and (ii) the integration with other components in a network is complicated.

Therefore, it is desirable to have a software based, open service integration system, implemented as an application server, which is adaptable to deal with the aforementioned deficiencies of the prior art service integration systems, and able to work in conjunction with the various types of communication networks, such as the telephony networks, the IN networks, the IP networks and hybrid networks (i.e. networks that combine the various types of communication).

### SUMMARY OF THE INVENTION

Accordingly, it is a principal object of the present invention to provide for a service integration system which will provide an open environment (i.e. the development of new services, their addition to the existing network and their integration with said existing network will be performed by the service integration system administrator, which will also be responsible for the service development (“service developer” or “system administrator”). As a result, the procedure of developing and integrating of new services will be relatively shorter and cheaper.

It is yet another object of the present invention to allow for the development of new services which are integrated with the existing network infrastructures, (e.g. the development by the service developer of a sophisticated billing service that uses a carrier's billing infrastructure).

Yet another object of the present invention is to implement a component within a service integration system which controls and regulates the packet flow both within the service integration system and between the service integration system and the communications network, wherein the regulation is performed in accordance with a modifiable policy, defined by the system administrator.

Yet another object of the present invention is to implement a service integration system which components are configurable by the system administrator.

Yet another object of the present invention is to implement a service integration system inherent to the communication network, which will enable better visibility and control of the signaling process.

Yet another object of the present invention is to allow the service integration system to directly communicate with different protocols such as IP, SS7 etc., by means of network adaptation components.

In accordance with a preferred embodiment of the present invention there is provided a software-implemented (i.e. a software running on a commodity computer, rather than on a special purpose machine), distributed service integration system for communication networks, said system comprising: at least one module for managing and controlling the various modules comprising the service integration system, executing management and control thereof, at least one module for sending and receiving messages from and to a network, at least one service logic execution environment module, and at least one resource control module, optimizing the flow of data both between the components of the service integration system, and between the service integration system and the network, the resource control module being connected at least with the module for sending and receiving messages from and to a network and with the service logic execution environment module, such that the service integration system is capable of at least one of the addition of services, the deployment of services, and the execution of services.

Additional features and advantages of the present invention shall become apparent from the following detailed description, accompanied with the following drawings.

### BRIEF DESCRIPTION OF THE DRAWINGS

In order to more fully understand the invention, an exemplary embodiment will now be described in detail, by way of non-limiting example only, with reference to the accompanying drawings, in which:

FIG. 1 is a schematic block diagram illustrating the structure of the present invention and the logical relations between the components thereof, and between the components thereof and the network;

FIG. 2 is a schematic block diagram illustrating a service logic execution environment in accordance with an exemplary embodiment of the present invention;

FIG. 3 is a flow chart illustrating the layout of a service execution process in accordance with an exemplary embodiment of the present invention; and

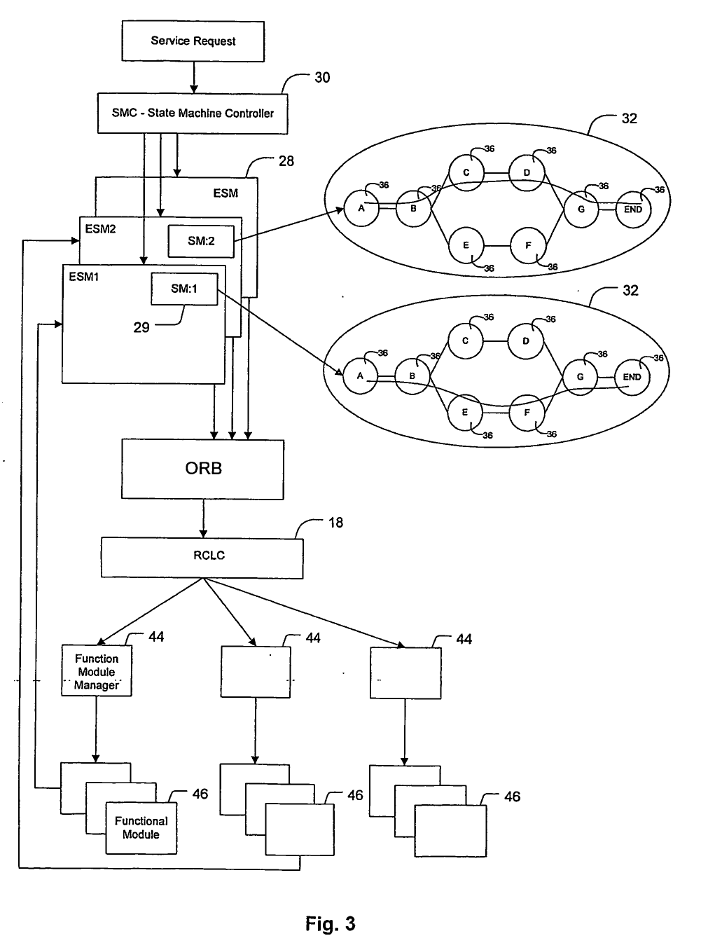

FIG. 4 is a schematic block diagram illustrating the network adaptors of the system of the present invention, and the logical relations and between the components thereof and other components of the present invention, all in accordance with an exemplary embodiment of the present invention.

### DETAILED DESCRIPTION OF AN EXEMPLARY EMBODIMENT OF THE PRESENT INVENTION

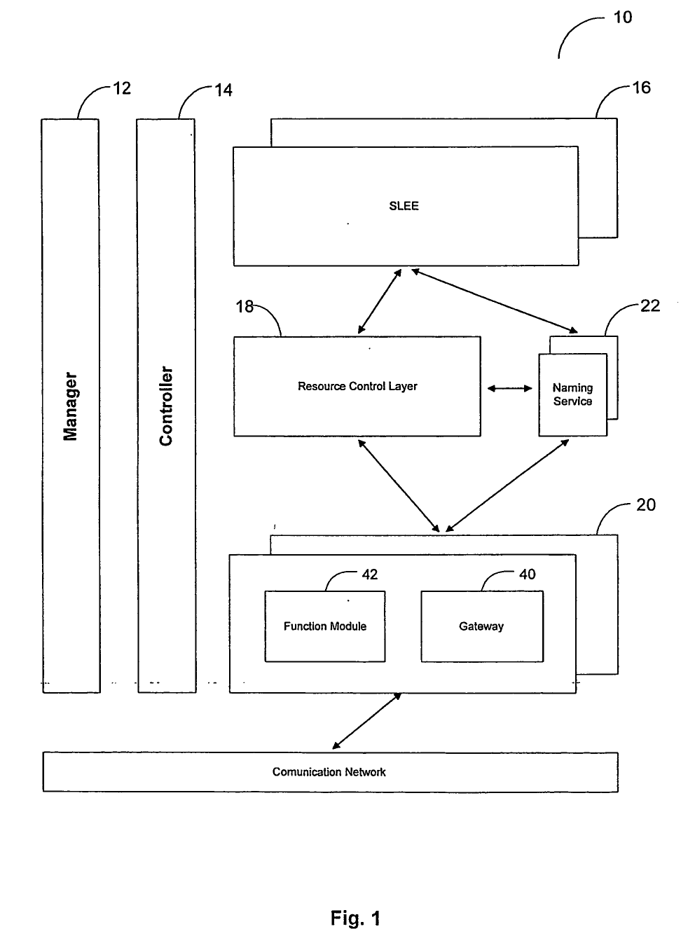

With reference to FIG. 1, disclosed herein is an exemplary embodiment of the service integration system of the present invention, known as “TappS” 10, which is a distributed service integration system for communication networks. TappS 10 is software-implemented (i.e. the service integration system of the present invention is a software running on a commodity computer, rather than on a special purpose machine). In this fashion, TappS 10 enables the deployment, execution and management of existing network services and the creation of new network services, which currently, in accordance with the prior art, are unavailable.

In accordance with the exemplary embodiment described herein, TappS 10 uses a distributed architecture and comprises of at least one manager module 12, at least one controller module 14, at least one service logic execution environment module (“SLEE”) 16, at least one resource control layer module (“RCLC”) 18, at least one functional module element 42, at least one gateway module 40 and at least one naming service module 22. Both functional module element 42 and gateway 40 are referred to together as network adaptors 20.

In accordance with the exemplary embodiment of the present invention, each of the abovementioned modules is implemented as a different computing station (“computer”). In accordance with an alternative embodiment of the present invention, one or more of the abovementioned modules share the same computer. The selection of the embodiment to be used depends on the resource usage of each of the modules, on the size of the network that uses the present invention, and on the networks' traffic rate.

The communication between the various components of TappS 10 is executed by means of the Common Object Request Broker Architecture, commonly referred to as CORBA (“CORBA”). Connections that require for higher transportation rate, such as between functional module element 42 and RCLC 18, are performed by means of protocols which are proprietary to TappS 10. These proprietary protocols are transported by means of standard network protocols, such as TCP and UDP. More specifically, communication between SLEE 16 and RCLC 18, between RCLC 18 and network adaptors 20, and between RCLC 18 and naming service 22, in that direction only, use the TappS 10 proprietary protocols. All other communications use the CORBA Internet Inter ORB protocol (“IIOP”).

A summary of the description of the abovementioned modules of TappS 10, and their functions follows:

Manager 12 is an interface, which allows the system administrator to configure each of the modules comprising TappS 10, as will be described hereinbelow. Manager 12 configures the various TappS 10 modules by accessessing controller 14, and instructing it to configure the TappS 10 modules. Manager 12 is operated by the system administrator, by means of a graphical user interface.

Controller 14 monitors and maintains the various TappS 10 modules. Controller 14 locates malfunctions, handles redundancy, provides fault tolerance and replaces or restarts any of the modules comprising TappS 10, which are down or malfunctioning. Controller 14 also upgrades the various system modules of TappS 10 in the event of a release of a new version, in which case, controller 14 is able to replace all of the TappS 10 modules, other than itself. If controller 14 requires replacement, said replacement is performed by means of manager 12.

The restarting of a module by means of controller 14 can either be initiated by the system administrator, or automatically, by controller 14, whenever it detects a need to restart a module (e.g. when a module has crashed).

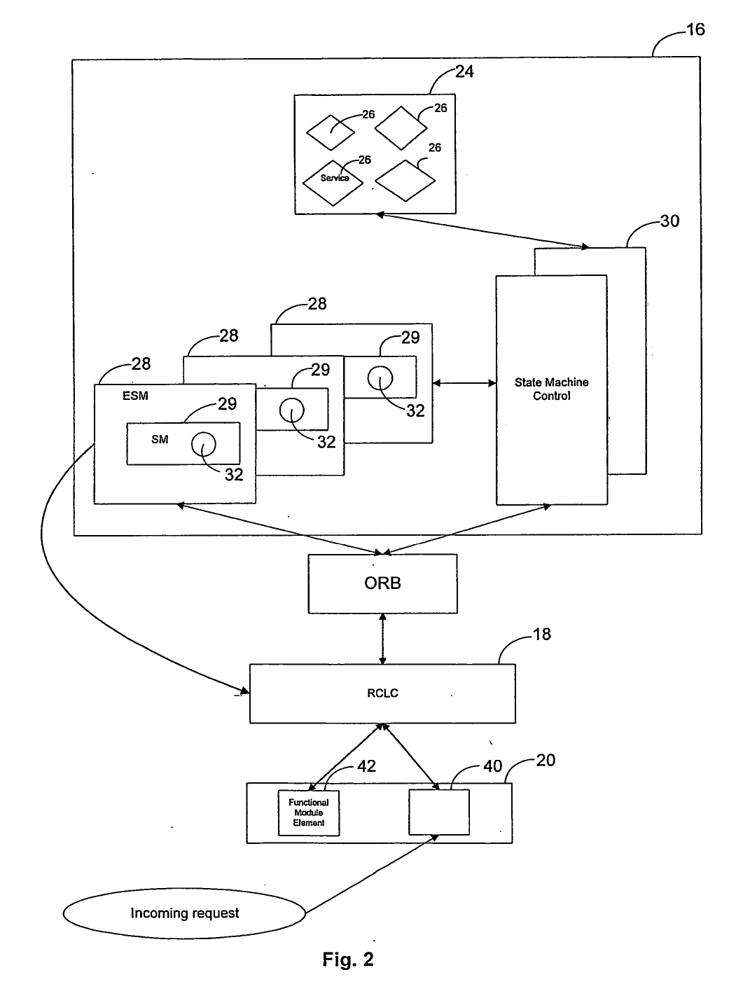

With reference to FIG. 2, SLEE 16 is the module that provides the environment in which services provided by TappS 10 are executed. Services comprise applications developed by the service developer, consisting of program code that models a state machine. SLEE 16 comprises at least one state machine controller 30, at least one memory module 24, and at least one executable state machine 28, the executable state machine 28 further comprising at least one state machine 29.

SLEE 16 stores the service logic of various network services 26 in memory 24. The various services 26 are represented as state machines. SLEE 16 is responsible for the execution of the various services provided by TappS 10. Each service 26 is represented by means of a state graph, where each node on the graph represents a state of the service 26. A state is a static entity, which encapsulates a set of values and instructions as to the way in which the service should be executed, and of the way of resolving the successor state of the running service. The state graph defines all possible nodes of a service 26, and therefore describes all the paths a certain service 26 can take upon its execution. The connecting segment between any two states (or nodes) is referred to as a state transition. Execution of a service 26 is performed by means of running over the state nodes of the state graph representing the service 26. The entire collection of state nodes of a service 26 is not required at the beginning of the execution of a service 26 because each of the state nodes following the first state node is dynamically resolved by the service 26, as it executes. It should be noted that not all state nodes must be present in memory when the service starts executing, however the state graph describing the service 26 includes all possible branchings of the service and exists in full, independently of the execution state.

Services 26 (i.e. state graphs) are executed by means of executable state machines 28. Executable state machines 28 are generic engines that execute the services 26 provided by TappS 10. SLEE 16 comprises at least one executable state machine 28.

The two main components of SLEE 16 are the executable state machine 28 and the state machine controller 30. The state machine controller 30 manages the free executable state machines 28 awaiting for new service requests.

The main responsibility of state machine controller 30 is to receive incoming requests, retrieve the state graph representing the requested service 26, and assign the state graph for execution to a free executable state machine 28. The state machine controller 30 manages the content of memory 24, which contains all of the valid services 26 (i.e. state graphs) supported by TappS 10. When state machine controller 30 receives a request for a new service, it retrieves the matching service 26 from memory 24, and assigns it for execution to an executable state machine 28. Once the assignment is made, state machine controller 30 no longer communicates with the running service 32. A secondary responsibility of state machine controller 30 is to maintain the required resources for the assignment and execution of service requests such as monitoring the correctness of the running executable state machine objects 28, monitor memory usage etc.

An executable state machine 28 is responsible for the execution of a single service 26. Between executable state machine 28 and a running service 32, there is a mediating layer which is state machine 29. State machine 29 is the component within which executable state machine 28 runs the service.

Executable state machine 28 also maintains a connection between the running service 32 and the functional module element 42. In many cases, several functional module elements 42 may be required by the service. The connection is maintained by means of RCLC 18, as will be explained hereinbelow. Along the execution process, the running service 32 posts tasks for the functional module element 42. These tasks contain the data required for the execution of the current state node. The operation of the functional module element 42 performing the tasks posted by the running service 32, and that of the running service are asynchronous. They are asynchronous in the sense that once a running service 32 sends a task to be executed by the functional module element 42, it continues to perform operations related with the service execution process simultaneously with the operation of the functional module element 42, and without waiting for the results generated by the functional module element 42.

The interaction between the executable state machine 28 and the functional module element 42 is as follows—tasks are sent from executable state machine 28 to functional module element 42 by means of RCLC 18. Once a task is completed by functional module element 42, the result is sent back to the executable state machine 28. Executable state machine 28 receives the result and assigns it to the state machine 29 that maintains the current state. Once the result is received, the state machine 29 communicates the current state node of the running service 32 for the purpose of resolving the next state node on the state graph of the service 26.

SLEE 16 has at least one executable state machine 28, and in accordance with the exemplary embodiment of the present invention it has a plurality of executable state machines 28, referred to as a pool. When a new service request is received by the state machine controller 30, an executable state machine 28 instance is assigned for the execution thereof. The assigned executable state machine 28 takes the state graph of the service 26, and runs it until its completion. When the assigned executable state machine 28 finishes executing the service, it is released back to the pool of free executable state machines 28, where it awaits for another assignment. Each executable state machine 28 running a service has its own unique reference, according to which messages destined for said executable state machine 28 are routed. Routing of these messages to the executable state machines 28 is performed in the following manner—modules external to SLEE 16 route all messages destined for executable state machines 28 to state machine controller 30. These external components know the location of the state machine controller 30 according to its CORBA address, commonly referred to as Interoperable Object Reference (“IOR”), which is communicated to these external components by state machine controller 30 upon its initiation. Once a message destined for one of the executable state machines 28 reaches the state machine controller 30, state machine controller 30 further routes the message to the executable state machine 28 to which the message pertains. If the message is a new service request, state machine controller 30 resolves the matching service 26 from memory 24, and assign it for execution by a free executable state machine 28 (i.e. modules external to SLEE 16 only “knows” state machine controller 30. State machine controller 30 “knows” the executable state machines 28), as will be further explained hereinbelow.

Each running service 32 knows its current state, and also how to resolve the following state of its execution. The current state is executed via executable state machine 28. The execution of a current state is terminated with a task sent to functional module element 42, by means of RCLC 18. Functional module element 42 executes the task and returns a result to executable state machine 28, again, via RCLC 18. The returned result is the input according to which the next state of the running service 32 is resolved.

TappS 10 supports deterministic execution of services 26. Each service 26 has its critical deadlines and paths defined in the first state node. When a service is assigned to an executable state machine 28, the executable state machine 28 knows the critical paths and deadlines before execution of the service begins. During the execution of the service 26, all of these critical limitations must be met, otherwise, execution of the service 26 is terminated, and an exception is thrown. These exceptions are caught and handled by state machine controller 30.

Every service 26 has its priority degree. Priority of a service is calculated by means of state machine controller 30 before it is assigned to an executable state machine 28 for execution. Priority is calculated as a factor of the service's estimated execution time, and time to live.

For better understanding of the process of executing a service by SLEE 16, hence is a description of a typical execution scenario, in accordance with the exemplary embodiment of the present invention—service execution begins with an incoming service request arriving at SLEE 16, by means of RCLC 18. Such incoming service requests are referred to state machine controller 30, which initiates the process of service execution. State machine controller 30 locates the requested service in memory 24 and assigns it for execution to a free instance of an executable state machine 28, selected out of the free executable state machine pool. In the next step, executable state machine 28 is activated by state machine controller 30. State machine controller 30 activates an -executable state machine 28 by assigning it a service 26 for execution. Once executable state machine 28 is activated, it initiates a new state machine 29 instance, which calls for the first state node 36 of the state graph of the service 26, thereby beginning the execution process. Nodes 36 of the running service 32 post tasks for functional module element 42, and handle the results received from functional module element 42. Said traffic between state nodes 36 and functional module element 42 is performed via RCLC 18. Executable state machine 28 receives the results of the handling of the tasks from functional module element 42, and refers these results to the state node 36 which initiated the task. What follows is that the state node 36 resolves the next state node on the state graph by evaluating information available in the current state, along with the result received from functional module element 42. Execution continues until the last state node 36 of the state graph of the service 26 is reached, thereby ending the service execution process. When the execution terminates, the state machine 29 is released, and the executable state machine 28 returns to the free executable state machine pool.

With respect to the architecture of SLEE 16, the two components receiving remote invocations from outside SLEE 16 are the state machine controller 30 and the executable state machine 28. Therefore in accordance with the exemplary embodiment of the present invention, the architecture of both components is distributed. This is implemented by means of CORBA. Thus, there are in SLEE 16, two CORBA owned objects—the state machine controller 30, and the executable state machine 28. For each platform running a SLEE 16 (there can be one or more, as explained hereinabove), there is implemented a running Object Request Broker (“ORB”). Each of said ORBs has two components within SLEE 16 owned by it—the state machine controller 30, and the executable state machine 28. The ORB environment channels the communication coming into SLEE 16 to the state machine controller 30 and the executable state machine 28, and provides them with the various functions such as pool threading, persistency etc., provided by the ORB environment. In accordance with alternative embodiments of the present invention, distributed implementations other than CORBA can be used, such as Remote Method Invocation (“RMI”), which is part of the Java programming language library.

As abovementioned, outgoing communication from SLEE 16 to RCLC 18 is performed by means of the proprietary protocols of TappS 10.

With reference to FIG. 6, there is shown a typical layout of a service execution process. As shown, each of executable state machines 28 No. 1 and No. 2 is running a service. For each running service there is a state machine object 29 that represent the corresponding execution context of the service 26. During service execution, tasks are posted to the functional module element 42, again, through RCLC 18. Functional module element 42 receives the task, executes it, and sends the result back to the executable state machine 28 from which the task originated using a CORBA call. Functional module element 42 knows how to send the reply to the originating executable state machine 28 according to the IOR it received with the task. Other than the IOR, the task also contains data regarding the definition of the current state 36, and the identity of the executable state machine 28 executing the service 26.

In accordance with the exemplary embodiment of the present invention, a plurality of state machine controllers 30 and a plurality of executable state machines 28 are used. In accordance with an alternative embodiment of the present invention, only one state machine controller 30 is used. The reason for this is that state machine controller 30 is a reentrant object, and therefore one instance thereof can be accessed by more than one request.

In accordance with the exemplary embodiment of the present invention, both state machine controller 30 and executable state machine 28 run on the same computer, and interrelate with one ORB. As abovementioned, the functional module element 42 may run on a different computer. The three of these components are responsible for the functional operation of SLEE 16. RCLC 18, is the component responsible for the non-functional requirements, such as flow control.

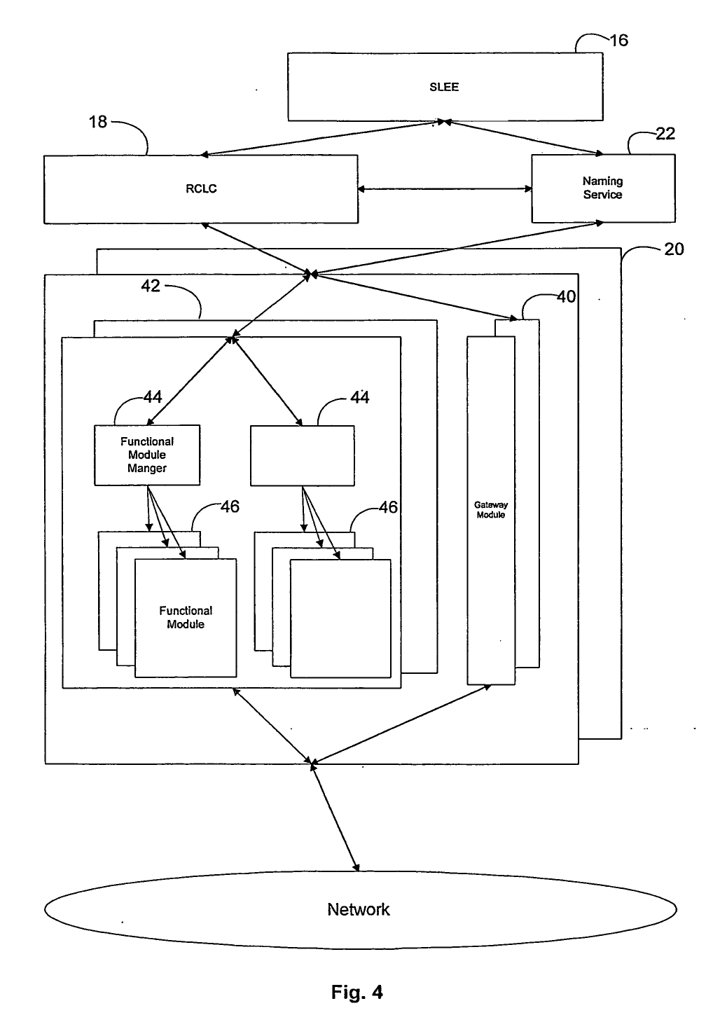

With reference to FIG. 4, network adaptors 20 are comprised of two main modules. The first is gateway module 40, and the second is functional module element 42. Gateway module 40 is implemented as a server, listening for incoming messages on a network interface such as SS7, IP etc.

Messages received by gateway module 40 are categorized to service requests and to external tasks. Service requests are external requests for the execution of a new service, received from the network, and therefore lead to the execution of a new service. External tasks, on the other hand, are external messages which relate to an already running service, and therefore will not cause the execution of a new service, but rather be channeled to an already running service 32. These external tasks are different from the abovementioned tasks which originate from within TappS 10 itself, for instance, the tasks that originate from SLEE 16, and are destined for the functional module element 42.

Functional module element 42 is responsible for processing tasks received from SLEE 16, and for further communicating the different network protocols with the results of the processing.

Functional module element 42 is a building block, comprising at least one functional module manager 44 and at least one functional module 46, used to implement services. A service is implemented by invoking a series of functional module elements 42. An example of an operation performed by functional module element 42 is posting a query to a database. For instance, once certain data is required by a running service 32, the functional module element 42 is contacted by the running service 32 with a request for the data. The request, as well as other requests, addressed to the functional module element 42 are generally referred to as tasks. The tasks contain the required parameters with which the query is executed. Once functional module element 42 receives a task, it contacts the proper network with the query. Results from the query are received by gateway component 40, and are then channeled to SLEE 16 (to be used by the running service 32) after consulting with naming service 22 as to the address of the running service 32 within SLEE 16.

In accordance with the exemplary embodiment of the present invention there are several types of functional modules 46, one to communicate each protocol that is supported by TappS 10.

The aforementioned different types of messages are transferred to the functional module element 42 via RCLC 18.

The component within functional module element 42 that receives the requests from RCLC 18 is the functional module manager 44. Functional module manager 44 serves as an interface between RCLC 18 and functional module 46, which is responsible for task handling. All instances of functional module 46 of a specific type are controlled by one functional module manager 44, so that for every type of functional module on a specific platform, there is one functional module manager 44. In accordance with the exemplary embodiment described herein, both functional module 46 instances, and functional module manager 44 which controls them are located on the same computer. Functional module 46 instances are managed by functional module manager 44 in the form of a pool. Functional module manager 44 holds a list of references to all functional module instances 46 of the same type, and maintains constant contact with them, so that functional module manager 44 knows at all times which of the instances of functional module 46 are free.

Functional module manager 44 also controls the number of functional module instances 46 which exist on a certain machine. The amount of existing functional modules 46 is determined in accordance with the load of tasks received by functional module manager 44. When required, functional module manager 44 creates, deletes, activates and shuts functional module instances 46. Functional module manager 44 also manages a short queue of unissued requests, awaiting issuance.

Once functional module manager 44 receives a task, its first priority is to route it to a free functional module 46 instance. If no such free instance exists, the task is transferred to the queue of unissued requests, and a method used to balance the number of functional module 46 instances is called.

The tasks are assigned to the functional module 46 instance for the purpose execution thereby. Once execution is over, the state of the functional module 46 instance is changed to idle, which means that it is free for execution of more tasks.

At the end of each task execution, functional module manager 44 calls for the abovementioned method, used to balance the number of functional module 46 instances. Said method checks the current load and task posting rate, and reduces or increases the number of functional module 46 instances accordingly.

In addition to the above, functional module manager 44 informs RCLC 18 as to the load on functional module 46 instances in relation to the number of existing functional module 46 instances, and the load on the general resources of the platform running them (e.g. I/O, CPU, memory etc.).

Once a task is allocated to a free functional module 46, said functional module 46 executes the task. For the purpose of executing the task, functional module 46 connects, if required, to devices that are external to TappS 10, such as a network interface card etc.

As a general principle, functional module 46 is built of three layers: (i) An interface layer, by means of which functional module 46 is communicated and communicates other components; (ii) A logic layer, which provides the actual service logic of functional module 46, said service logic being implemented separately for every type of functional module 46; (iii) the hardware adaptation layer, which exists only in functional module 46 types that use hardware, such as network interface cards. This third layer is used by the logic layer to communicate with the hardware related to said functional module. For the purpose of maintaining vendor independence, functional modules that connect with different types of hardware devices has independently implemented hardware adaptation layers.

Functional module manager 44 and RCLC 18 are connected via a proprietary network protocol. Connection between the two components is created by means of consulting naming service 22. Each functional module 46, upon its creation, consults naming service 22 for the location of its corresponding RCLC 18 and the designated port thereof. Once the data is obtained by the newly created functional module 46, functional module 46 contacts RCLC 18 for the purpose of notifying RCLC 18 of its existence.

In a similar manner, a newly created RCLC 18, upon creation, consults naming service 22 for the location of all existing functional modules 46, and connects to them. Once contact is made, all following traffic between RCLC 18, and functional module 46 is made through the specific port, using a predefined protocol. Once connection is established, functional module 46 opens a thread that constantly listens on said port, and which identifies requests that are channeled from RCLC 18.

Different types of events, other than in the form of the abovementioned tasks, are time triggered events, such as having RCLC 18 check for load within functional module element 42, and having functional module element 42 inform RCLC 18 as to its load status. These time triggered events are handled by another thread that identifies the time triggered event and calls for the required method.

The main function of RCLC 18 is monitoring traffic loads both within TappS 10 and between TappS 10 and the network. RCLC 18 knows these loads' status at any given time, learns the resource consumption behavior of the various services provided by TappS 10, and channels the traffic of the incoming and outgoing messages in accordance therewith. RCLC 18 also operates in accordance with a predetermined policy, pre-set by the system administrator. For instance, the system administrator can define certain priorities with respect to the importance degree of the various services 26 provided by TappS 10, therefore the execution of services 26 of higher importance will receive priority over the execution of services 26 of lesser importance.

Naming service 22 maintains a list of SLEE 16 computers and their IORs, and of the services currently running therein. When a message arrives from the network, the gateway 40 contacts naming service 22 for the destination to which the incoming message should be routed. Naming service 22 returns the gateway 40 an IOR of the correct SLEE 16, to which the message should be routed. Other components of TappS 10 also query naming service 22 for routing information in a similar manner to that described hereinabove.

As abovementioned, TappS 10 has the capabilities of adding new services into communication networks, deploying services, and handling service requests received from the communication networks. Following is a general description of the method in which TappS 10 handles service requests.

Once it is recognized by a network that a certain session requires the execution of a service, a message requesting the provision of the required service is sent to TappS 10.

The component within TappS 10 responsible for detecting incoming messages is gateway 40. A message may either be a new service request or an external event that relates to an already running service. Once a message is received by TappS 10, gateway 40 consults naming service 22 to find out whether the message relates to a running service or is it a new service request. If the message is an external event that relates to an already running service, the location of the running service's 32 is fetched, and the external event is channeled via RCLC 18 as a parameter to be used by the running service 32, running within SLEE 16. If the message is a new service request, it is channeled via RCLC 18 to SLEE 16, where the requested service 26 is resolved and service execution begins. The running service 32, running within SLEE 16 which receives messages that are external events, arriving from the network, process these external events, and sends tasks back to the function module element 42, again via RCLC 18. The function module element 42 processes these tasks, which results in one of two outcomes—either in changes at the function module element 42 state, or in one or more network messages being sent back to the running service 32. In a typical scenario, task execution causes one or more messages to be sent to the network and/or to the running service. After function module element 42 sends the messages to the network and/or to the running service 32, it receives responses from the network and/or new tasks from the running service 32. This process takes place until service execution is terminated.

A prerequisite for executing services 26 by means of the TappS 10, is having the required services 26 deployed with TappS 10. TappS 10 allows the service developer to develop and deploy new services 26 to be requested by users of a network and executed by TappS 10. In accordance with the present invention, development of new services is achieved by means of high level computer languages (e.g. Java etc.). TappS 10 provides the system administrator with an Application Programming Interface (“API”) on top of which the new services' source code is developed. Once the development of a new service is finished, the source code is compiled, and once compiled, the binary code is transferred into SLEE 16 by means of controller 14 (controller 14 is operated by the system administrator deploying the new service by means of manager 12, which, as abovementioned, provides the system administrator with a GUI to TappS 10). In the following step, the binary code is then linked into the SLEE 16 using Java class loading facilities (which is similar to dynamically loaded libraries). After these steps, the new service can be activated by the system administrator, and has full access to the TappS 10 facilities.

Once deployed, the service is added to memory 24 within SLEE 16, and immediately thereafter becomes a valid service provided by TappS 10, and therefore ready for execution.

All of subject matter disclosed hereinabove is what gives TappS 10 unique capabilities. One of these capabilities is the ability to create a single session out of at least one call-control session and other sessions (e.g. Web sessions and database connections). Furthermore, the distributed architecture of TappS 10 enables the replication of all of its elements, as necessary to achieve properties such as enhanced fault tolerance, higher performance level and bigger capacity handling capabilities. TappS 10 is also network and protocol independent, with respect to telephony networks (i.e. the same service can run in PSTN, over INAP, in PSTN over ISUP, or in a next generation network over SIP without effecting any code changes). Moreover, it should be specifically stated that TappS 10 is not limited to a telephony network as are some of the prior art service integration systems, and therefore, for instance, service sessions can be started in response to non-telephony events such as HTTP requests, RADIUS authentication requests as well as by other protocols. Another noticeable characteristic of TappS 10 is that it holds a complete view of the resources being consumed by all active sessions, and therefore can prioritize and throttle resource consumption, both for internal resources (within the TappS 10 system) and external resources such as network bandwidth etc. It is this last characteristic that also enables deterministic traffic control both within the TappS 10 system, and between the TappS 10 system and the network.

In conclusion, it should of course be understood that the foregoing description of an exemplary embodiment of the present invention is merely an example. It is anticipated and expected that one of skill in the art may make many alterations and modifications of the exemplary embodiment and still be within the spirit and scope of the present invention which is solely determined by reference to the claims appended hereto.

What is claimed is:

1. A distributed service integration system for communication networks, implemented as an application server, comprising:
(a) at least one module for managing and controlling said service integration system, interacting with each of the modules comprising said service integration system for the purpose of executing management and control thereof;
(b) at least one module for sending and receiving messages from and to a network;
(c) at least one service logic execution environment module; and
(d) at least one resource control module, optimizing the flow of data both between the components of said service integration system, and between said service integration system and the network, such that said resource control element is connected at least with said module for sending and receiving messages from and to a network and with said service logic execution environment module;
wherein all of the above modules are interacting with required corresponding hardware equipment for the purpose of executing their respective functions.

2. The service integration system of claim 1, wherein said at least one module for managing and controlling said service integration system is separated into at least one module for managing said service integration system and into at least one module for-controlling said service integration system.

3. The service integration system of claim 1, wherein said at least one module for sending and receiving messages from and to a network is separated into at least one gateway module and to at least one functional module element.

4. The service integration system of claim 1, wherein said service integration system supports asynchronous execution of network services.

5. The service integration system of claim 1, wherein said distributed architecture enables replication of the elements comprising said service integration system to provide at least one of the following, selected from the group consisting of:
(a) fault tolerance;
(b) performance; and
(c) capacity.

6. The service integration system of claim 1, wherein said service integration system is constantly aware of the resources consumed by all handled sessions.

7. The service integration system of claim 1, wherein said service integration system controls the amount of resources allocated to the different sessions handled by said service integration system.

8. The service integration system of claim 1, enabling deterministic traffic control both within the TappS 10 system, and between the TappS 10 system and the network.

9. The service integration system of claim 1, wherein said network is a real-time communication network transporting time-sensitive traffic.

10. The service integration system of claim 1, wherein said network is a data-communication network.

11. The service integration system of claim 1, wherein said network is a hybrid-communication network combining at least voice-communication with data-communication.

12. The service integration system of claim 3, wherein said at least one functional module element further comprises:
(a) at least one functional module manager; and
(b) at least one functional module.

13. The service integration system of claim 3, wherein said at least one service logic execution environment module further comprises:
(a) at least one state machine controller;
(b) at least one memory; and
(c) at least one executable state machine.

14. The service integration system of claim 1, wherein said at least one resource control element further optimizes flow of traffic in accordance with a pre determined policy defined by the system administrator.

15. The service integration system of claim 1, wherein said at least one resource control element further analyzes and stores historical system resource consumption rates of the various services provided by said service integration system, and uses the stored data for optimizing the flow.

16. The service integration system of claim 1, wherein said service integration system is capable of at least one of the following, selected from the group consisting of:
(a) deployment of services;
(b) execution of services; and
(c) management of services.

17. The service integration system of claim 13, wherein said at least one executable state machine further comprises at least one state machine.

18. A distributed architecture service integration system for communication networks, implemented as an application server, comprising:
(a) at least one means for managing and controlling said service integration system, interacting with a plurality of the means comprising said service integration system for the purpose of executing management and control thereof;
(b) at least one means for sending and receiving messages from and to a network;
(c) at least one means for providing a service logic execution environment for the purpose of running a service; and
(d) at least one means for optimizing the flow of data both between the components of said service integration system, and between said service integration system and the network, such that said means for optimizing the flow is connected at least with said means for sending and receiving messages from and to a network and with said means providing a service logic execution environment.

19. The service integration system of claim 18, wherein said service integration system is capable of at least one of the following, selected from the group consisting of:
(a) deployment of services;
(b) execution of services; and
(c) management of services.

20. A method for providing services in a communication network comprising the steps of:
(a) receiving a new message from said communication network;
(b) checking with an independent centralized network resource if said new message is a new service request or is it a message relating to an already executing service;
(c) if said new message relates to an already executing service, channeling said new message to the executing service to which it pertains;
(d) if said new message is a new service request, channeling said new message to a service logic execution environment for execution of the requested service, and performing steps (e) and (f);
(e) resolving the requested service from the services supported by said service integration system; and
(f) executing said resolved service.

21. A method in accordance with claim 20 wherein said step (f) further comprises the steps of:
(a) posting tasks by said executing service for execution by said service integration system;
(b) processing said tasks by said service integration system; and
(c) receiving new messages by the executing service from both the communication network and said service integration system.

22. A method in accordance with claim 21 wherein said step (b) further comprises the steps of:
(a) sending messages to the communication network; and
(b) sending messages to said executing service.

23. A method for deploying new services for communication networks, comprising the steps of:
(a) implementing said new service by means of a high level computer language source code;
(b) compiling said source code; and
(c) integrating said compiled source code with said communication network by means of installing said compiled source code into a memory, where said new service is ready to be executed.

24. A method for controlling flow of traffic both within a service integration system and between a service integration system and between said service integration system and a communication network, comprising the steps of:
(a) determining the expected resource consumption needs of a received task;
(b) determining the resource load level of external network channels;
(c) determining the resource load level of internal network channels; and
(d) forwarding a message into a selected network channel in accordance with the results received from performing steps (a), (b) and (c).

25. The service integration system of claim 9 wherein said time sensitive traffic is voice.

26. The service integration system of claim 9 wherein said time sensitive traffic is video.
